(19) United States
(12) Patent Application Publication
(10) Pub. No.: US 2009/0092381 A1
(43) Pub. Date: Apr. 9, 2009

(54) RECORDING DEVICE AND RECORDING METHOD

(76) Inventor: Etsuto Nakatsu, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 11/914,771

(22) PCT Filed: May 12, 2006
(86) PCT No.: PCT/JP2006/309565

§ 371 Date: Nov. 19, 2007

(30) Foreign Application Priority Data
May 20, 2005 (JP) 2005-147861

(51) Int. Cl. H04N 5/00

(52) U.S. Cl. 386/126; 386/E05.064

(57) ABSTRACT

A recording apparatus according to the present invention includes: a recording section for generating a first recording signal for recording visual information, showing the contents of data to be written on an information storage medium in a visible form, on the information storage medium; and a head section for recording the visual information on the information storage medium based on the first recording signal by using predetermined address information, which is stored on the information storage medium, as a reference for aligning the visual information being recorded such that the visual information is directly visible to a user. The recording section further generates a second recording signal for writing location information, showing where the visual information has been recorded on the information storage medium, on the information storage medium. And the head section writes the location information on the information storage medium based on the second recording signal.

### TECHNICAL FIELD

The present invention relates to a recording apparatus and recording method for not only writing data optically on an information storage medium but also recording visual information on the information storage medium in the form that is directly visible to the user.

### BACKGROUND ART

Recording apparatuses for writing compressed video and audio data on optical disk media have become rapidly popular these days. A DVD (digital versatile disc) recording apparatus is one such recording apparatus. With a DVD recording apparatus, the user can record a broadcast TV program on a DVD disk using a scheduled recording function and can play back and watch and listen to it whenever he or she needs to. DVD disks have a storage capacity (i.e., the capacity to store content data) of 4.7 GB. When operating in an extended length recording mode, a DVD recording apparatus can record video for as long as four to eight hours on a single DVD disk. That is why normally a number of broadcast TV programs are recorded on a single optical disk medium by adding them to the same disk one after another, which means that after some content data has been written on an optical disk medium, another content data is written there as additional data.

In such a situation where a number of broadcast TV programs are recorded on the same disk by adding them to it one after another, if the user changes optical disk media to use according to the categories of the programs, for example, then there will be a lot of optical disk media with remaining spaces. To check out the available space that is left on such an optical disk medium (which will be simply referred to herein as a “remaining space”), the user should load the optical disk medium into his or her DVD recording apparatus, get the stored data information read, and then get the remaining space displayed on the TV screen, which is very troublesome.

Thus, to check out the remaining space on an optical disk medium more easily, a technique for displaying the remaining space on an optical disk medium even without loading it by calculating the remaining space on the DVD disk when recording on the disk is finished and storing the value in an internal memory of the appliance was proposed (see Patent Document No. 1, for example).
Patent Document No. 1: Japanese Patent Application Laid-Open Publication No. 2003-151244

### DISCLOSURE OF INVENTION

### Problems to be Solved by the Invention

According to the technique, however, the remaining space cannot be known unless the DVD recording apparatus is turned ON to get predetermined operations done. Also, to know the remaining spaces of a plurality of optical disk media, some marks (such as serial numbers) associated with optical disk media IDs to be displayed on the TV screen need to have been written down on the optical disk media, which is troublesome, too. Furthermore, the remaining space still cannot be known with an appliance other than the DVD recording apparatus used unless the optical disk medium is actually loaded into the appliance.

In order to overcome the problems described above, the present invention has an object of providing a recording apparatus and recording method that allows the user to know the remaining space on an optical disk medium with no trouble just by making him or her directly look at the surface of the optical disk medium. Another object of the present invention is to provide a recording apparatus and recording method that allows the user to align locations to record pieces of visual information with each other easily when the visual information, which tells the user the contents of the data stored at a glance at the surface of the optical disk medium, is recorded on the optical disk medium.

### Means for Solving the Problems

A recording apparatus according to the present invention is characterized by including: a recording section for generating a first recording signal for recording visual information, showing the contents of data to be written on an information storage medium in a visible form, on the information storage medium; and a head section for recording the visual information on the information storage medium in response to the first recording signal by using predetermined address information, which is stored on the information storage medium, as a reference for aligning the visual information being recorded such that the visual information is directly visible to a user.

In one preferred embodiment, the recording section further generates a second recording signal for writing location information, showing where the visual information has been recorded on the information storage medium, on the information storage medium, and the head section writes the location information on the information storage medium in response to the second recording signal.

In another preferred embodiment, the data includes at least one of video data, audio data, text data, and program data.

In still another preferred embodiment, the visual information includes at least one of the title, file name and recording date of the data.

A recording method according to the present invention is characterized by including the steps of: generating a recording signal for recording visual information, showing the contents of data to be written on an information storage medium in a visible form, on the information storage medium; and recording the visual information on the information storage medium in response to the recording signal by using predetermined address information, which is stored on the information storage medium, as a reference for aligning the visual information being recorded such that the visual information is directly visible to a user.

Another recording apparatus according to the present invention is characterized by including: a recording section for generating a first recording signal for recording visual information, showing the contents of data to be written on an information storage medium in a visible form, on the information storage medium; and a head section for recording the visual information on the information storage medium in response to the first recording signal such that the visual information is directly visible to a user. The recording section further generates a second recording signal for writing location information, showing where the visual information has been recorded on the information storage medium, on the information storage medium. And the head section writes the location information on the information storage medium in response to the second recording signal.

In one preferred embodiment, in recording additional visual information, the head section aligns the additional visual information with the visual information that has already been recorded in accordance with the location information.

In another preferred embodiment, the head section records the visual information by using the storage location of predetermined address information, which is stored on the information storage medium, as a reference for aligning the visual information being recorded.

In still another preferred embodiment, the data includes at least one of video data, audio data, text data, and program data.

In yet another preferred embodiment, the visual information includes at least one of the file name, title and recording date of the data.

Another recording method according to the present invention is characterized by including the steps of: generating a first recording signal for recording visual information, showing the contents of data to be written on an information storage medium in a visible form, on the information storage medium; recording the visual information on the information storage medium in response to the first recording signal such that the visual information is directly visible to a user; generating a second recording signal for writing location information, showing where the visual information has been recorded on the information storage medium, on the information storage medium; and writing the location information on the information storage medium in response to the second recording signal.

Another recording apparatus according to the present invention is characterized by including: a recording section for generating a first recording signal for recording remaining space information, showing the space remaining on an information storage medium in a visible form, on the information storage medium; and a head section for recording the remaining space information on the information storage medium in response to the first recording signal such that the remaining space information is directly visible to a user.

In one preferred embodiment, at least one set of data and the remaining space information are already stored on the information storage medium. If new data has been added to the information storage medium, the recording section generates a second recording signal for recording update information, showing a remaining space that has changed due to the addition of the new data, on the information storage medium. And the head section records the update information on the information storage medium in response to the second recording signal and updates the remaining space information that is stored on the information storage medium.

In another preferred embodiment, the remaining space information is represented as a graphic and/or letters.

In still another preferred embodiment, the remaining space information is represented as a graphic and/or letters, and the update information is represented as an additional graphic and/or additional letters to be added to at least one of the graphic and the letters representing the remaining space information.

In yet another preferred embodiment, the remaining space information is represented as a ring, and the update information is represented as an additional ring that is concentric with the ring and that is added to either inside or outside of the ring on the information storage medium.

In yet another preferred embodiment, the information storage medium has a mark that indicates a reference location in a circumferential direction of the information storage medium, and the head section records the update information on the information storage medium by reference to the location of the mark such that the remaining space information and the update information are aligned with each other.

In yet another preferred embodiment, the head section records the update information on the information storage medium by reference to the storage location of predetermined address information, which is stored on the information storage medium, such that the remaining space information and the update information are aligned with each other.

In yet another preferred embodiment, the recording section further generates a third recording signal for writing location information, showing the storage location of the remaining space information on the information storage medium, on the information storage medium, and the head section writes the location information on the information storage medium in response to the third recording signal.

In this particular preferred embodiment, the head section records the update information on the information storage medium by reference to the location information such that the remaining space information and the update information are aligned with each other.

In yet another preferred embodiment, in erasing the remaining space information stored, the recording section generates an erase signal for erasing the remaining space information, and the head section erases the remaining space information in response to the erase signal.

In yet another preferred embodiment, the data includes at least one of video data, audio data, text data, and program data.

Another recording method according to the present invention is characterized by including the steps of: generating a recording signal for recording remaining space information, showing the space remaining on an information storage medium in a visible form, on the information storage medium; and recording the remaining space information on the information storage medium in response to the recording signal such that the remaining space information is directly visible to a user.

### EFFECTS OF THE INVENTION

According to the present invention, visual information is recorded by using predetermined address information, which is stored on an information storage medium, as a reference for aligning the visual information that is going to be recorded. As a result, the locations to record the visual information can be aligned with each other even without leaving any special alignment mark on the information storage medium.

Also, according to the present invention, location information, representing the location where the visual information has been recorded on the information storage medium, is written on the information storage medium. Therefore, when additional visual information is recorded, the stored visual information and the additional visual information can be aligned with each other easily by reference to the location information.

Furthermore, according to the present invention, remaining space information, showing the remaining space on an information storage medium visually, is recorded on the information storage medium in the form that is directly visible to the user. Since the remaining space on an information storage medium has been recorded on the surface of the optical disk medium in the form that is easily recognizable to his or her eye, the user can know the remaining space on the information storage medium instantaneously just by casting a glance at the surface of the information storage medium shortly.

### BRIEF DESCRIPTION OF DRAWINGS

FIG. 1A shows a recording apparatus according to a first preferred embodiment of the present invention.

FIG. 1B shows a piece of remaining space information according to the first preferred embodiment of the present invention.

FIG. 1C shows another piece of remaining space information according to the first preferred embodiment of the present invention.

FIG. 2 shows a relation between the remaining space and the number of rings according to the first preferred embodiment of the present invention.

FIG. 3 is a flowchart showing the procedure of recording remaining space information according to the first preferred embodiment of the present invention.

FIG. 4A shows how the optical disk medium of the first preferred embodiment of the present invention may look after the remaining space information has been deleted from it.

FIG. 4B shows how the optical disk medium of the first preferred embodiment of the present invention may look after the remaining space information has been deleted from it.

FIG. 5A shows a piece of remaining space information according to a second preferred embodiment of the present invention.

FIG. 5B shows another piece of remaining space information according to the second preferred embodiment of the present invention.

FIG. 6 shows a relation between the remaining space and the color depth of the ring according to the second preferred embodiment of the present invention.

FIG. 7 is a flowchart showing the procedure of recording remaining space information according to the second preferred embodiment of the present invention.

FIG. 8A shows how the optical disk medium of the second preferred embodiment of the present invention may look after the remaining space information has been deleted from it.

FIG. 8B shows how the optical disk medium of the second preferred embodiment of the present invention may look after the remaining space information has been deleted from it.

FIG. 9A shows a piece of remaining space information according to a third preferred embodiment of the present invention.

FIG. 9B shows another piece of remaining space information according to the third preferred embodiment of the present invention.

FIG. 10A shows a reference mark used as a reference for alignment according to the third preferred embodiment of the present invention.

FIG. 10B shows a reference sector used as a reference for alignment according to the third preferred embodiment of the present invention.

FIG. 11A shows a recording apparatus according to the third preferred embodiment of the present invention.

FIG. 11B shows a label side divided into multiple lines according to the third preferred embodiment of the present invention.

FIG. 12A shows how the optical disk medium of the third preferred embodiment of the present invention may look after the remaining space information has been deleted from it.

FIG. 12B shows how the optical disk medium of the third preferred embodiment of the present invention may look after the remaining space information has been deleted from it.

FIG. 13A shows a piece of remaining space information according to a fourth preferred embodiment of the present invention.

FIG. 13B shows another piece of remaining space information according to the fourth preferred embodiment of the present invention.

FIG. 14A shows how the optical disk medium of the fourth preferred embodiment of the present invention may look after the remaining space information has been deleted from it.

FIG. 14B shows how the optical disk medium of the fourth preferred embodiment of the present invention may look after the remaining space information has been deleted from it.

### DESCRIPTION OF REFERENCE NUMERALS

1 first recording section
2 second recording section
3 head section
4 playback AV processing section
12 recording AV processing section
13 recording signal generating section
14 optical head section
15 optical disk medium
16 playback section
17 reference location detecting section
18 control section
19 bitmap image generating section
20 drawing section
21 drawing head section
22 drawn area management section

### BEST MODE FOR CARRYING OUT THE INVENTION

Hereinafter, preferred embodiments of a recording apparatus and recording method according to the present invention will be described with reference to the accompanying drawings, in which any pair of components shown in multiple drawings and having the same function is identified by the same reference numeral and the same component will not be described again once given a detailed description.

### Embodiment 1

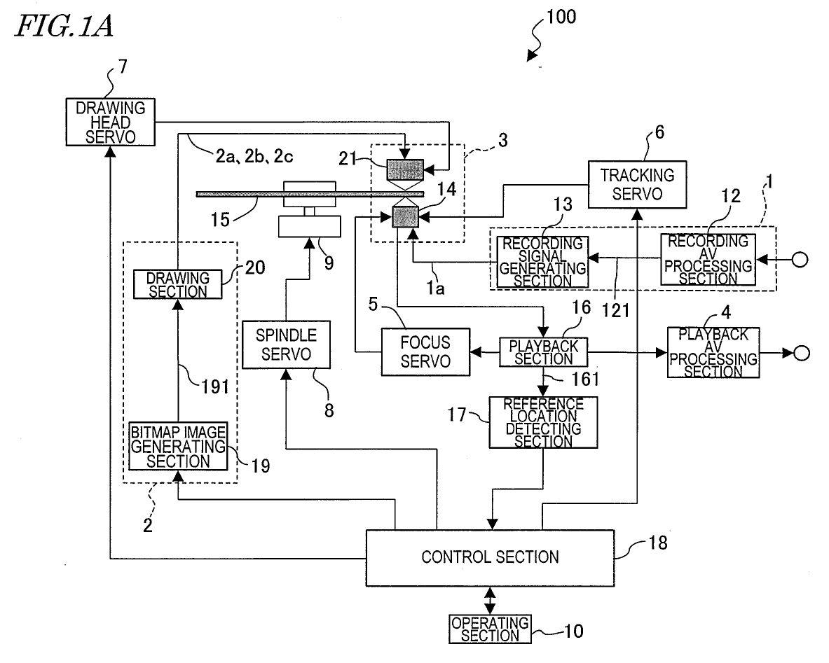

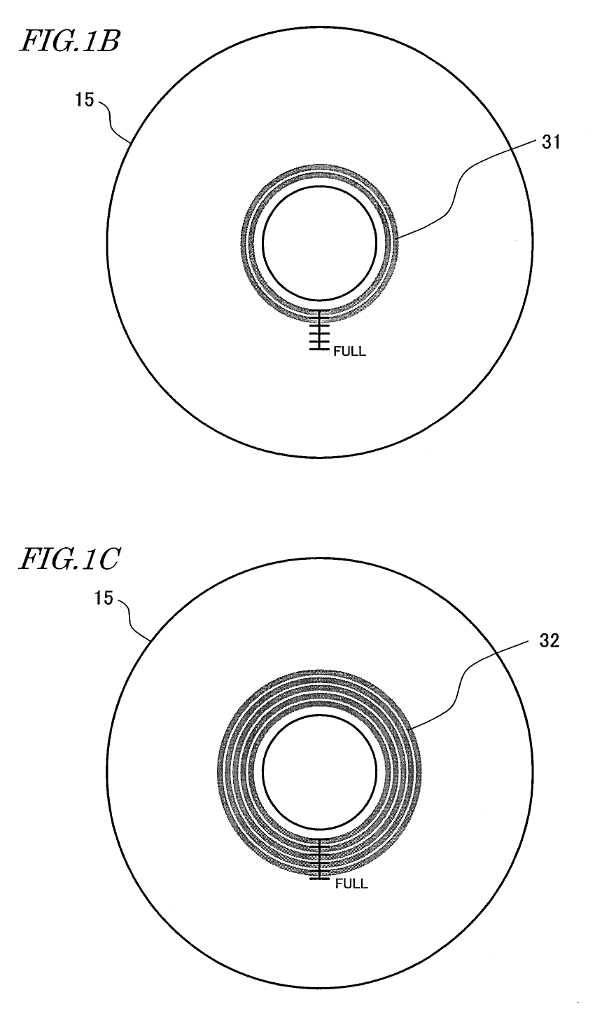

A first preferred embodiment of a recording apparatus and recording method according to the present invention will be described with reference to FIGS. 1A through 4B.

First, look at FIG. 1A, which shows a recording apparatus 100 according to the first preferred embodiment.

The recording apparatus 100 includes a first recording section 1 for generating a recording signal 1a to write content data on an optical disk medium 15, a head section 3 for writing the content data on the optical disk medium 15 responsive to the recording signal 1a, and a second recording section 2 for generating a recording signal 2a to record remaining space information, showing the remaining space on the optical disk medium 15 visually, on the optical disk medium 15. The content data may be video data, audio data, or a combination thereof. Also, according to the type of the recording apparatus 100, text data, program data or any other type of appropriate data may be written on the optical disk medium 15. In response to the recording signal 2a, the head section 3 records the remaining space information on the optical disk medium 15 in the form that is directly visible to the user.

In the following description of preferred embodiments, the first and second recording sections 1 and 2 are supposed to be two different components. However, the first and second recording sections 1 and 2 may be formed as an integral component. Also, the first and second recording sections 1 and 2 will sometimes be referred to herein as a “recording section” collectively.

The recording apparatus 100 includes a playback section 16, a playback AV processing section 4, a reference location detecting section 17, a control section 18, an operating section 10, a focus servo mechanism 5, a tracking servo mechanism 6, a drawing head servo mechanism 7, a spindle servo mechanism 8, and a motor 9.

The first recording section 1 includes a recording AV processing section 12 and a recording signal generating section 13. The second recording section 2 includes a bitmap image generating section 19 and a drawing section 20. The head section 3 includes an optical head section 14 and a drawing head section 21.

Next, it will be described how this recording apparatus 100 operates. The recording apparatus 100 is loaded with an optical disk medium 15. In accordance with the user's command entered into the operating section 10, broadcast content data (including video data and audio data) to be recorded is externally input to the recording AV processing section 12 and the video data and the audio data are compressed separately and multiplexed together, thus generating an AV stream 121. The AV stream 121 is supplied to the recording signal generating section 13, where an error correction code is added thereto and recording modulation is performed thereon, thereby generating a recording signal 1a to write content data on the optical disk medium 15. The read/write optical head section 14 receives the recording signal 1a and writes the content data on the optical disk medium 15. When the content data is read or written, the optical disk medium 15 is rotated by a motor that is controlled by the spindle servo mechanism 8. The position of the optical head section 14 is controlled by the focus servo mechanism 5 and the tracking servo mechanism 6. The control section 18 controls the operations of all components of the recording apparatus 100.

After the broadcast content data has been written, the written data is read from the optical disk medium 15. The read signal, generated by the optical head section 14, is supplied to the playback section 16 and subjected to demodulation and error correction there, thereby generating a read data signal 161, which is then input to the playback AV processing section and the reference location detecting section 17. The playback AV processing section 4 converts the read data signal 161 into a signal that can be displayed appropriately on an external device such as a display monitor and then outputs it to the external device. The operation of the reference location detecting section 17 will be described later.

The control section 18 detects the remaining space on the optical disk medium 15 and the title of the content data from the read data signal 161. The bitmap image generating section 19 generates remaining space information representing the detected remaining space visually and visual information representing the title of the content data written. The drawing section 20 converts the remaining space information and the visual information into a recording signal 2a to be written on the optical disk medium 15. On receiving the recording signal 2a, the drawing head section 21 records the remaining space information and the visual information on the label side (i.e., non-data storage side) of the optical disk medium 15. The remaining space information and the visual information are recorded in the form that is directly visible to the user. The position of the drawing head section 21 is controlled by the drawing head servo mechanism 7.

FIGS. 1B and 1C show pieces 31 and 32 of remaining space information that were recorded on the label side of the optical disk medium 15. The remaining space information 31 and 32 is represented by a graphic and/or letters. In this example, the remaining space information is represented by concentric rings that are drawn with respect to the center of the optical disk medium 15.

As content data is written on the same optical disk medium 15 more and more times, the remaining space decreases gradually and the number of concentric rings, written outward from the inner edge of the optical disk medium 15 toward the outer edge thereof, increases, thereby representing the remaining space.

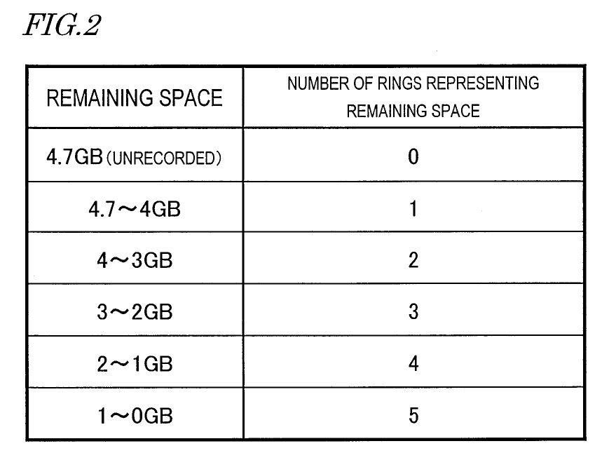

FIG. 2 shows an exemplary relation between the remaining space and the number of rings. On an unrecorded optical disk medium on which no content data has been written yet, nothing is stored at all. However, the more the content data is written, the less the remaining space. As a result, the number of rings increases from one through five according to the remaining space. An optical disk medium on which five rings have been written has a remaining space of 1 GB or less.

FIG. 3 is a flowchart showing the procedure of recording the remaining space information. First, in Step S100, an unrecorded optical disk medium 15 is loaded into the recording apparatus 100 (see FIG. 1). In Step S101, the recording apparatus 100 writes content data for the first time. After it has been written, the control section 18 detects the remaining space on the optical disk medium 15 in Step S102. If the remaining space X detected is 3.5 GB, for example, the second recording section 2 and the head section 3 generate a recording signal 2a to record two rings and write the signal 2a in Step S103. If necessary, the second recording section 2 and the head section 3 also generate and write a recording signal 2a to leave a remaining space scale in Step S104. As a result of these processing steps, the remaining space is visually shown as rings on the surface of the optical disk medium as shown in FIG. 1A. Then, the user can see instantaneously that there is a remaining space of 3 to 4 GB just by casting a glance at the two rings. In this case, the remaining space information is recorded on the label side by the “LightScribe” technique. For further details of the “LightScribe” technique, go to http://www.lightscribe.com. Drawing can be done by providing a heat sensitive layer on the label side and by irradiating the heat sensitive layer with a laser beam.

Next, it will be described how to add another set of content data to the optical disk medium 15 on which at least one set of content data has already been written. First, the optical disk medium 15 is loaded into the recording apparatus 100. If the given optical disk medium 15 is a recorded optical disk medium, the control section 18 detects the remaining space on the optical disk medium 15 in Steps S100 and S105. If the remaining space Y detected is 3.5 GB, for example, the control section 18 determines that two rings have already been written. Subsequently, the recording apparatus 100 adds another set of content data in Step S106. After the content data has been written, the control section 18 detects the remaining space on the optical disk medium 15 in Step S107. Suppose the remaining space Z detected is 0.5 GB, for example. Since two rings have already been written, the second recording section 2 and the head section 3 generate and write a recording signal 2b to write the three (i.e., the third through fifth) rings in Step S108. As a result, those three rings are added as the third through fifth concentric rings to the outside of the two rings that have already been written. By writing those three (third through fifth) rings as update information representing the remaining space that has changed due to the addition of the new content data, the remaining space information shown on the surface of the disk medium is updated. As a result of these processing steps, the updated remaining space information 32 is shown visually as rings on the surface of the optical disk medium as shown in FIG. 1B. The user can see instantaneously that there is a remaining space of 0 to 1 GB just by casting a glance at the five rings written there.

Also, by representing the remaining space information as concentric rings, there is no need to align the remaining space information being recorded in the circumferential direction. Consequently, compared to the situation where character information needs to be written, the recording control can be simplified.

It should be noted that if no data can be added to an optical disk medium anymore (e.g., if there is almost no remaining space on the optical disk medium due to the addition of data), the remaining space information could be deleted either in accordance with the user's instruction or automatically. The rings and scale representing the remaining space may be erased if they can. For example, if a reversible heat sensitive recording material as disclosed in Japanese Patent Application Laid-Open Publication No. 11-151856 is provided on the label side, the remaining space information can be erased by making the drawing head section 21 irradiate the remaining space information storage location with an erasing laser beam. The reversible heat sensitive recording material disclosed in Japanese Patent Application Laid-Open Publication No. 11-151856 includes a leuco dye and a reversible developer. The leuco dye may be 3-di-n-butylamino-6-methyl-7-anylenofluoran and the reversible developer may be N-[3-(p-hydroxyphenyl)propiono]-N′-n-octadecanohydrazide, for example. However, any other compound may also be used. By condensing a laser beam on the reversible heat sensitive recording layer on the label side to make it generate heat, remaining space information can be recorded (drawn) on, or erased from, the reversible heat sensitive recording layer. To draw a colored image on the reversible heat sensitive recording layer, the storage location may be heated and then cooled rapidly. This can be done by irradiating that location with a laser beam for a short time. The second recording section 2 and the head section 3 generate recording signals 2a and 2b to emit laser beam pulses for such short irradiation and emit those laser beam pulses. The remaining space information is erased by irradiating the reversible heat sensitive recording layer with a laser beam for a relatively long time. In that case, even peripheral portions of the reversible heat sensitive recording layer are heated, the cooling rate slows down, and the remaining space information storage portions can be recovered to their original state. In this manner, the remaining space information can be erased. In erasing the remaining space information, the second recording section 2 and the head section 3 generate an erase signal 2c to emit laser beam pulses for such long irradiation and emit those laser beam pulses.

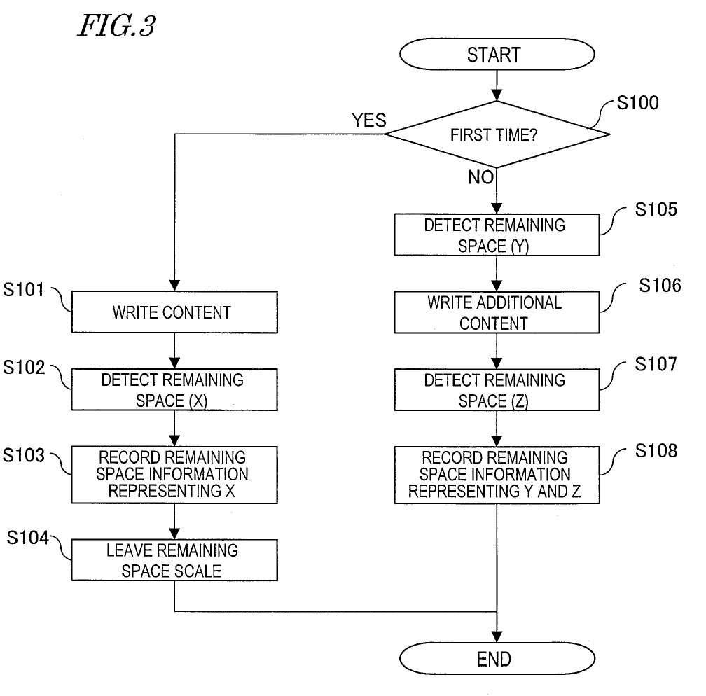

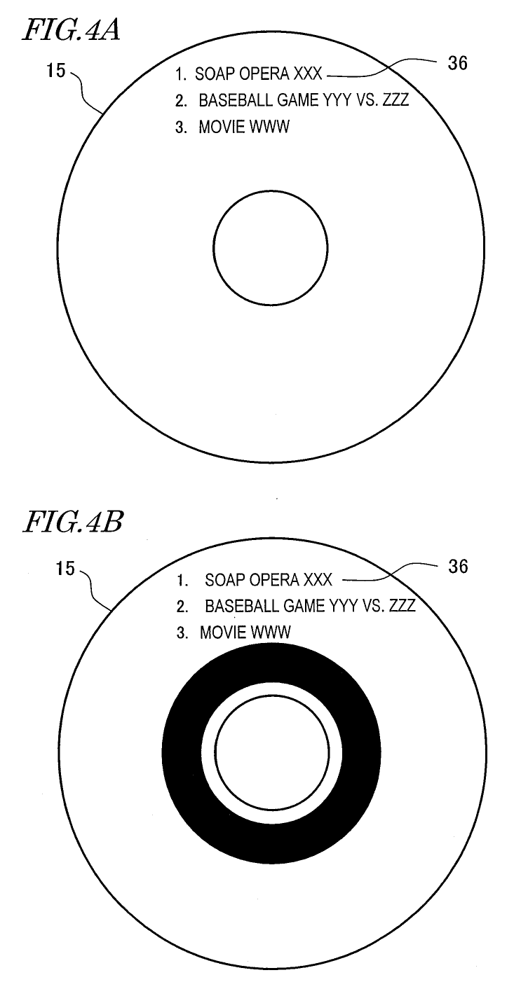

Also, when the remaining space information is erased, information about content data stored (such as its title) may be read from the data storage side and printed on the label side of the optical disk medium. It would be convenient because the user can see at a glance what contents are stored. Examples of the visual information to be recorded on the label side include titles, file names, recording dates and a combination thereof. FIG. 4A shows pieces of visual information 36 that are recorded on the label side, from which the remaining space information has been erased.

Furthermore, if remaining space information cannot be erased from the optical disk medium used, a graphic can be overwritten so as to hide the remaining space information by painting it out. In this manner, the remaining space information can be substantially deleted.

In the example described above, the remaining space is shown visually by increasing the number of rings from the inner edge toward the outer edge. Alternatively, the remaining space may also be shown visually by increasing the number of rings inward from the outer edge toward the inner edge. Still alternatively, if rings can be erased, a number of rings that is proportional to the remaining space at the time of first recording may be written. And every time the remaining space decreases due to the addition of data, the number of rings may be decreased by erasing one ring after another.

Also, in the example described above, concentric rings representing remaining space information are supposed to be written on the label side. Alternatively, concentric rings and titles may also be written on a data unwritten area that has been provided in advance on the data storage side, not on the label side. Graphics may be drawn on the data storage side by DiscT@2 technique. For further details of the DiscT@2 technique, go to http://www.yamaha.co.jp/.

### Embodiment 2

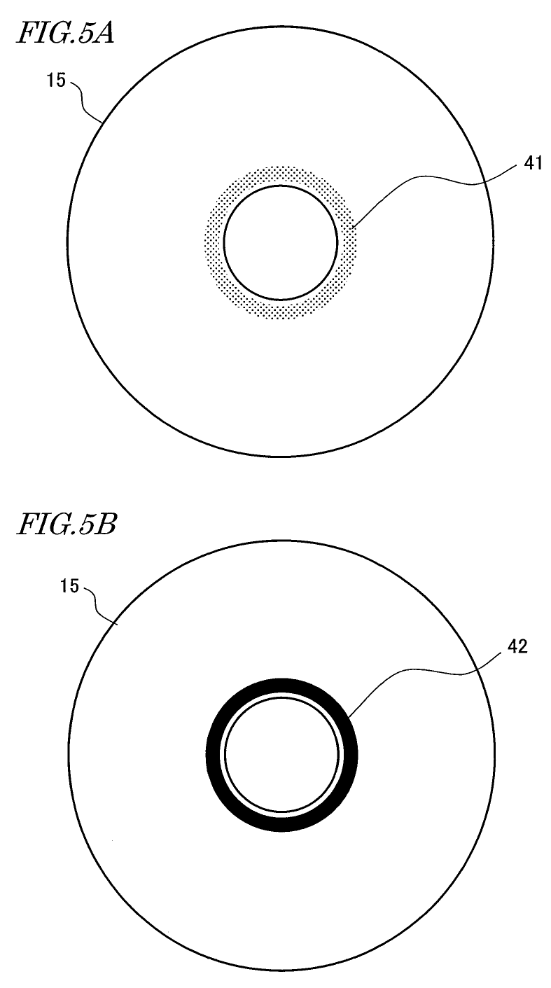

FIGS. 5A and 5B show pieces 41 and 42 of remaining space information that have been recorded on the label side of an optical disk medium 15 according to this preferred embodiment. These pieces 41 and 42 of remaining space information may be recorded by the recording apparatus 100 (see FIG. 1A).

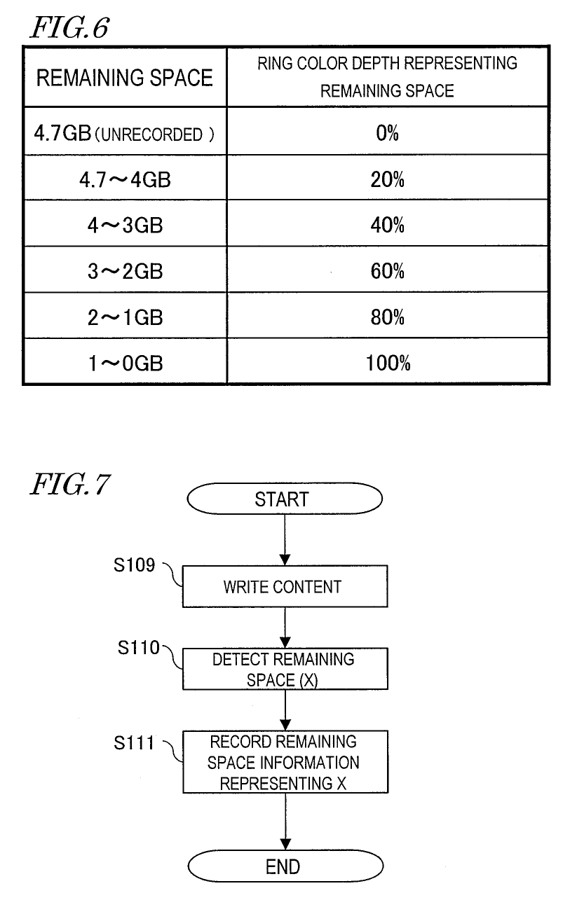

In this preferred embodiment, as the remaining space decreases due to repetitive addition of content data, the color depth of the ring that has been drawn on the surface of the optical disk medium changes. FIG. 6 shows an exemplary relation between the remaining space and the ring color depth. On an unrecorded optical disk medium on which no content data has been written yet, nothing is stored at all. However, the more the content data is written, the less the remaining space. As a result, the ring color depth increases from 20% through 100% according to the remaining space. An optical disk medium with a ring color depth of 100% has a remaining space of 1 GB or less. The ring color depth can be controlled by adjusting the power of the laser beam to emit or the irradiation time thereof. The color depth can also be changed according to the number of dots to be drawn.

FIG. 7 is a flowchart showing the procedure of recording the pieces 41 and 42 of remaining space information. First, an optical disk medium 15 is loaded into the recording apparatus 100 to write content data thereon in Step S109. After the write operation is over, the control section 18 detects the remaining space on the optical disk medium 15 in Step S110. If the remaining space X detected is 3.5 GB, for example, the second recording section 2 and the head section 3 perform the processing step of writing a ring with a color depth of 40% in Step S111. As a result, the remaining space is shown visually on the surface of the optical disk medium in such a shape as that shown in FIG. 5A. In that case, the user can see instantaneously that there is a remaining space of 3 to 4 GB just by casting a glance at the ring with a color depth of 40%.

Alternatively, if the remaining space detected X is 0.5 GB, the second recording section 2 and the head section 3 perform the processing step of writing a ring with a color depth of 100% in Step S111. As a result, the remaining space is shown visually on the surface of the optical disk medium in such a shape as that shown in FIG. 5B. In that case, the user can see instantaneously that there is a remaining space of 0 to 1 GB just by casting a glance at the ring with a color depth of 100%.

By representing the remaining space by the color depth of the ring in this manner, the remaining space can be indicated with the disk area saved.

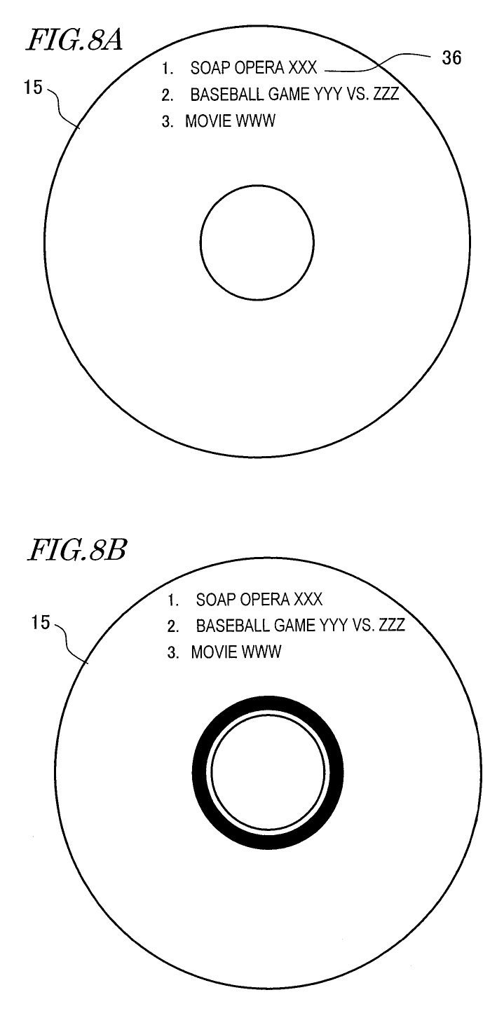

In a situation where the ring representing the remaining space can be erased, if no data can be added to an optical disk medium anymore (e.g., if there is almost no remaining space on the optical disk medium due to the addition of data), the remaining space information could be erased either in accordance with the user's instruction or automatically. Also, when the remaining space information is erased, information about content data stored (such as its title) may be read from the data storage side and printed on the label side of the optical disk medium. It would be convenient because the user can see at a glance what contents are stored on the optical disk medium as shown in FIG. 8A, which shows visual information 36 that has been recorded on the label side from which the remaining space information has been erased. Also, if remaining space information cannot be erased from the optical disk medium used, the titles may be printed with the ring left as it is as shown in FIG. 8B.

In the preferred embodiment described above, the remaining space is represented visually by changing the color depths of the ring. However, if the ring can be rewritten entirely, the remaining space information may also be updated by changing the colors of the ring.

Also, in the preferred embodiment described above, a ringlike graphic is drawn as a piece of remaining space information on the label side. Alternatively, the ring-like graphic and the titles may also be drawn on a data unwritten area that has been provided in advance on the data storage side, not on the label side.

### Embodiment 3

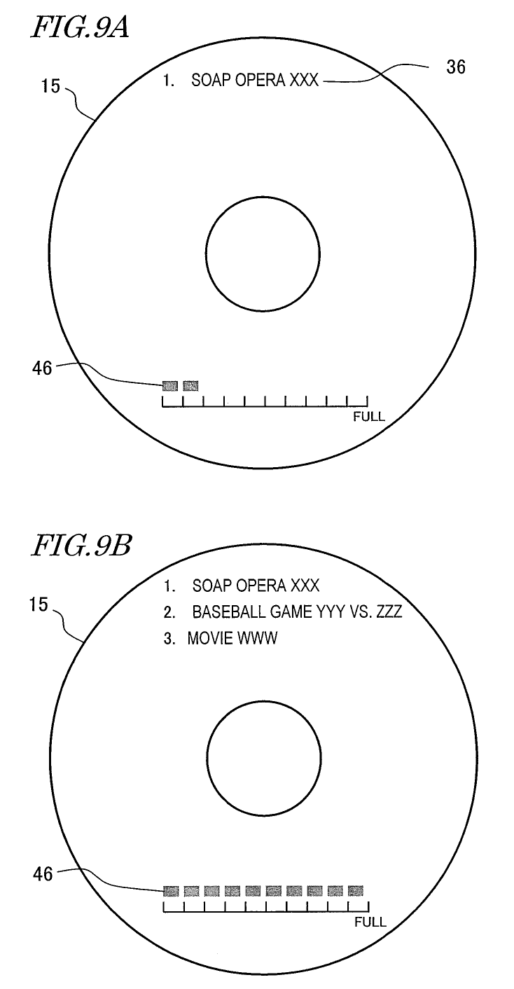

FIGS. 9A and 9B show remaining space information 46 that has been recorded on the label side of an optical disk medium 15 according to this preferred embodiment. The remaining space information 46 may be recorded by the recording apparatus 100 (see FIG. 1A).

In this preferred embodiment, as the remaining space decreases due to repetitive addition of content data, the bar indicator that has been drawn on the surface of the optical disk medium changes.

Hereinafter, the procedure of recording this remaining space information 46 will be described with reference to FIG. 3. First, in Step S100, an unrecorded optical disk medium 15 is loaded into the recording apparatus 100, which writes content data thereon for the first time in Step S101. After the write operation is over, the control section 18 detects the remaining space on the optical disk medium 15 in Step S102. If the remaining space X detected is 3.5 GB, for example, the second recording section 2 and the head section 3 generate and write a recording signal 2a to show two squares in Step S103. If necessary, the second recording section 2 and the head section 3 generate and write a recording signal 2a to leave a remaining space scale in Step S104. By performing these processing steps, the remaining space is shown visually on the surface of the optical disk medium 15 as a bar indicator such as that shown in FIG. 9A. In that case, the user can see instantaneously how much space is left just by casting a glance at the bar indicator. Also, information about content data stored (such as its title) may also be printed. It would be convenient because the user can see at a glance what contents are stored even if one of those contents is now being added.

Next, to add another set of content data, the optical disk medium is loaded into the recording apparatus 100. If the optical disk medium 15 is a recorded optical disk medium, the control section 18 detects the remaining space on the optical disk medium in Steps S100 and S105. If the remaining space Y detected is 3.5 GB, for example, the control section 18 determines that two squares have already been written. Subsequently, the recording apparatus 100 adds another set of content data in Step S106. After the content data has been written, the control section 18 detects the remaining space on the optical disk medium 15 in Step S107. Suppose the remaining space Z detected is 0.5 GB, for example. Since two squares have already been written there, the second recording section 2 and the head section 3 generate and write a recording signal 2b to write the eight (i.e., the third through tenth) squares in Step S108. As a result of these processing steps, the updated remaining space information is shown visually on the surface of the optical disk medium as shown in FIG. 9B. The user can see instantaneously that there is little remaining space just by casting a glance at the ten squares shown there.

In this preferred embodiment, the remaining space information 46 is represented as a bar indicator unlike the ring shape of the first and second preferred embodiments described above and the user can see the remaining space more easily. However, when the bar indicator needs to be updated, the squares should be added with the optical disk medium 15 aligned in the circumferential direction (i.e., in the rotational direction). Hereinafter, the procedure of the alignment will be described.

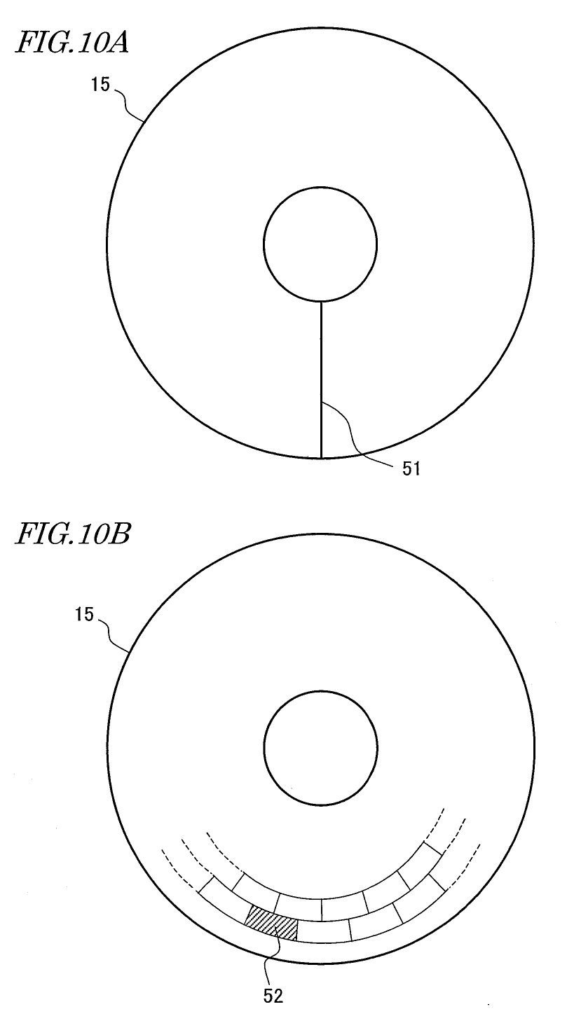

As an aid for a first exemplary alignment procedure, a reference line 51 extending in the radial direction of the optical disk medium 15 may have been left in advance as a mark on the label side thereof as shown in FIG. 10A. The reference line 51 can be located by making the head section 21 irradiate the label side with a laser beam and receive its reflected light. Based on the location of the reference line 51, the rotational velocity of the optical disk medium 15 and the position of the head section 21 in the radial direction of the optical disk medium 15, the beam spot on the label side can be located.

Meanwhile, a technique for making alignment in the rotational direction by detecting a marker that has been written in advance on the label side is disclosed in Japanese Patent Application Laid-Open Publication No. 2000-40264. According to this technique, when the remaining space and remaining space scale are recorded for the first time, a marker may also be written at a predetermined location. And when squares need to be added, the remaining space information may be updated after the alignment has been made by reference to that marker.

A second exemplary procedure for aligning the optical disk medium 15 in the rotational direction will be described. A track has been formed in the rotational direction on the data storage side of the optical disk medium 15. The track is a group of sectors, each having a fixed data length. And a unique ID (address information) on the track is given to each of those sectors in the group. For more details of the sector ID, see “O plus E”, Vol. 199, June 1996, New Technology Communications, pp. 93-97. If a particular sector (i.e., a reference sector with a particular ID) is defined as a reference in the rotational direction when content data is written on an unrecorded optical disk medium 15 for the first time, the reference sector may be detected, the alignment may be made in the rotational direction and then the visual information may be recorded. In this manner, the visual information can be recorded after alignment has been done properly. Also, when visual information should be added, the visual information to be newly recorded (which will be referred to herein as “update information”) and the previously written visual information may be aligned with each other properly before the update information starts to be recorded.

As shown in FIG. 1A, after the content data has been written, the written data is read from the optical disk medium 15. The read signal, generated by the optical head section 14, is supplied to the playback section 16 and subjected to demodulation and error correction there, thereby generating a read data signal 161, which is then input to the playback AV processing section and the reference location detecting section 17 that detects the address information (e.g., ID=0) of the reference sector.

The control section 18 defines the detected phase of the reference sector, representing the particular address information, as a reference (i.e., zero degrees) for the rotational direction. The bitmap image generating section 19 generates visual information, including the remaining space information and the title of the content data written, by reference to the location of the reference sector. The drawing section 20 converts the visual information into a recording signal 2a to be written on the optical disk medium 15. On receiving the recording signal 2a, the drawing head section 21 records the visual information on the label side of the optical disk medium 15. As a result, the remaining space information 46 and the title 36 are drawn on the label side as shown in FIG. 9A.

Next, the procedure of adding another set of content data to the recorded optical disk medium 15 and recording additional visual information thereon will be described. When the content data is added, the written data is read from the optical disk medium 15. The read signal, generated by the optical head section 14, is supplied to the playback section 16 and subjected to demodulation and error correction there, thereby generating a read data signal 161, which is then input to the reference location detecting section 17 that detects the address information (e.g., ID=0) of the reference sector.

The control section 18 defines the detected phase of the reference sector, representing the particular address information, as a reference (i.e., zero degrees) for the rotational direction. The bitmap image generating section 19 generates update information, including additional visual information such as the remaining space information and the title of the content data written, by reference to the location of the reference sector. The drawing section 20 converts the update information into a recording signal 2b to be written on the optical disk medium 15. On receiving the recording signal 2b, the drawing head section 21 records the update information on the label side of the optical disk medium 15. Also, the drawing head section 21 aligns the update information with the graphic or letters that have already been written on the label side using the recording signal 2b that has been generated by reference to the location of the reference sector, thereby adding the update information. As a result, updated remaining space information and titles are drawn on the label side as shown in FIG. 9B.

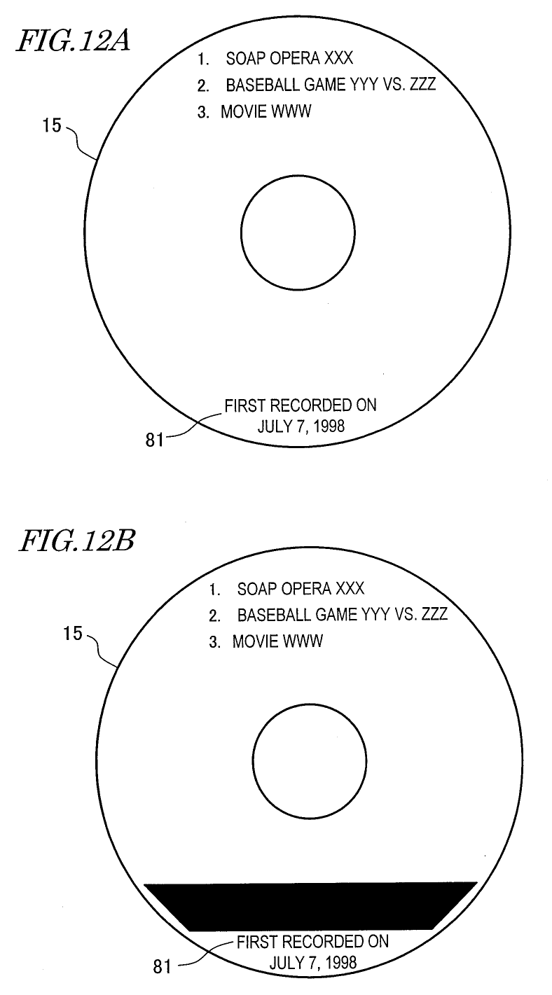

It should be noted that if no data can be added to an optical disk medium anymore (e.g., if there is almost no remaining space on the optical disk medium due to the addition of data), the remaining space information could be deleted either in accordance with the user's instruction or automatically. The bar indicator and the remaining space scale may be erased if they can. FIG. 12A shows the label side from which the bar indicator and the scale have been erased. In the example shown in FIG. 12A, the recording date 81 of the content data is left as a piece of visual information. Furthermore, if the bar indicator and remaining space scale cannot be erased, a graphic can be overwritten so as to hide the bar indicator and scale by painting them out as shown in. 12B. In this manner, the remaining space information can be deleted.

If the number of lines to write a title on as the visual information is limited to one per content, the locations to write the titles can be determined by the number of contents that have been written so far. To allow the title of a single content to cover multiple lines, location information representing the storage location of the visual information may be stored on the data storage side. And when some title needs to be added, the location information may be read and the additional title may be written after the location represented by the location information. For example, the label side may be divided into multiple lines and location information representing written lines and/or unwritten lines may be generated.

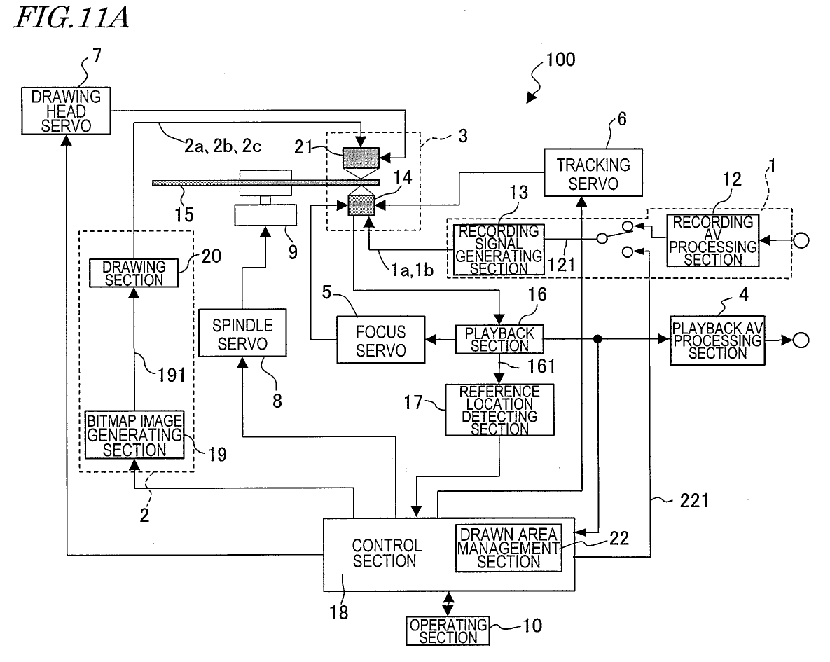

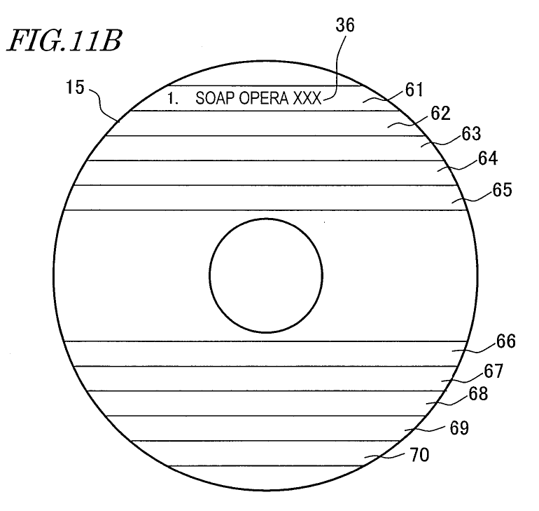

FIG. 11A shows a recording apparatus 100 for generating and writing location information. In the recording apparatus 100 shown in FIG. 1A, the control section includes a drawn area management section 22.

When content data and visual information, including the remaining space on the optical disk medium 15 and the titles, have been written, the drawn area management section 22 generates location information 221 representing drawn areas, which may be information indicating that the number of lines on which titles have been written is two and that the number of squares that have been written to represent the remaining space is five, for example.

The recording signal generating section 13 generates a recording signal 1b to write the location information 221 on the optical disk medium 15. On receiving the recording signal 1b, the optical head section 14 writes the location information 221 on the data storage side of the optical disk medium 15.

When more visual information needs to be added, the drawn area management section 22 gets the location information 221 read from the optical disk medium 15 by the playback section 16. Based on the information about the drawn area read, the location to record the additional visual information (such as a graphic and/or letters) is determined so as to be aligned with the visual information already stored. The second recording section 2 generates a recording signal such that the additional visual information is recorded on the storage location determined. And the head section 3 records the additional visual information (i.e., update information) after having aligned it with the stored visual information.

FIG. 11B shows a label side that has been divided into a number of lines 61 through 70. Since a title 36 has already been written on the first line 61, the drawn area management section 22 generates location information 221 indicating that the first line 61 has already been drawn. If such location information 221 is read, the drawn area management section 22 can determine that the additional visual information can be recorded on the second line 62 and so on.

Also, when the remaining space information should be erased, the remaining space information to erase may be located based on the location information 221 read and then erased.

In the preferred embodiment described above, a graphic like a bar indicator is supposed to be drawn as remaining space information on the label side. Such a graphic like a bar indicator and a title may also be drawn on a data unwritten area that has been provided in advance on the data storage side, not on the label side.

### Embodiment 4

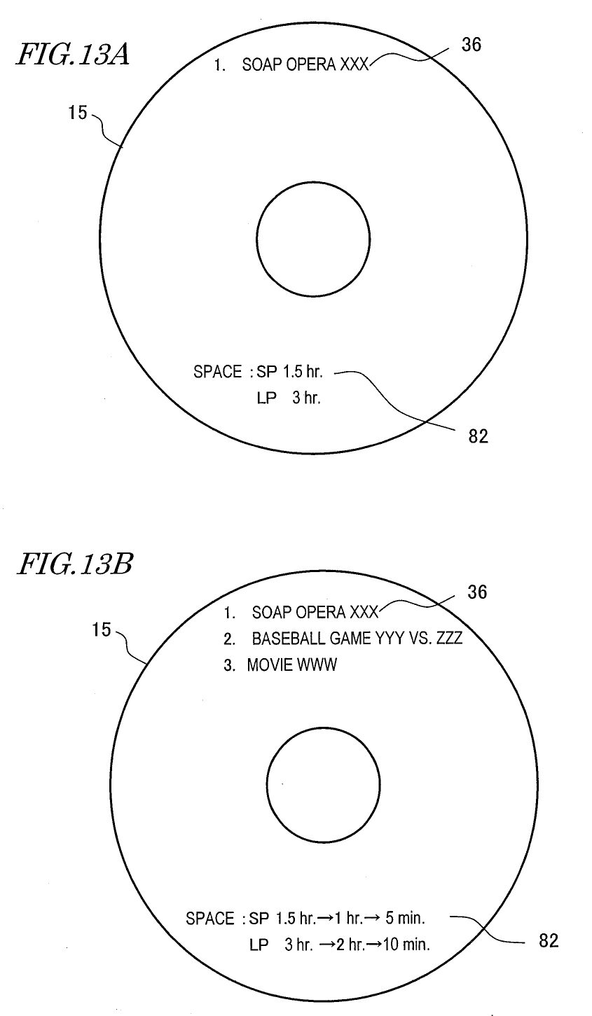

FIGS. 13A and 13B show remaining space information 82 that has been drawn on the label side of an optical disk medium 15 according to a fourth preferred embodiment of the present invention. The remaining space information 82 may be recorded by the recording apparatus 100 and is represented as letters.

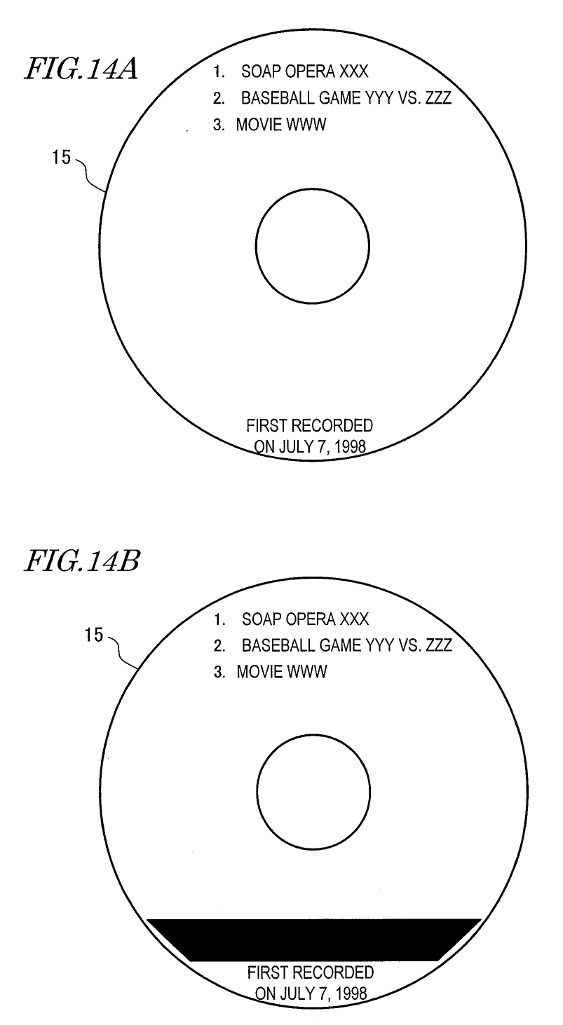

The more times content data are recorded, the less the remaining space. In this preferred embodiment, the remaining space is represented as recordable times in respective recording modes. For example, FIG. 13A shows how a label side looks when the remaining space information is recorded after content data has been written for the first time. On the other hand, FIG. 13B shows how the label side looks when additional content data have been written. Meanwhile, FIG. 14A shows how the label side looks after the remaining space information has been erased and deleted, while FIG. 14B shows how the label side looks after the remaining space information has been overwritten and deleted. The only difference between this preferred embodiment and the other preferred embodiments described above is how to display the remaining space information recorded. Thus, the processing of recording the remaining space information will not be described herein.

In this example, the writings on the label side are supposed to be non-erasable and the recordable times are updated with arrows as shown in FIG. 13. If the writings on the label side can be erased, however, the writings are preferably erased once and then update is preferably done by newly writing the latest recordable time. Then, the user can see the remaining recordable time more easily.

In the preferred embodiment described above, a recordable time is supposed to be written as letters representing remaining space information on the label side. The recordable time and a title may also be written on a data unwritten area that has been provided in advance on the data storage side, not on the label side.

As described above, a recording apparatus according to the present invention is characterized by including: a recording section for generating a first recording signal for recording visual information, showing the contents of data to be written on an information storage medium in a visible form, on the information storage medium; and a head section for recording the visual information on the information storage medium in response to the first recording signal by using predetermined address information, which is stored on the information storage medium, as a reference for aligning the visual information being recorded such that the visual information is directly visible to a user.

In one preferred embodiment, the recording section further generates a second recording signal for writing location information, showing where the visual information has been recorded on the information storage medium, on the information storage medium, and the head section writes the location information on the information storage medium in response to the second recording signal.

In another preferred embodiment, the data includes at least one of video data, audio data, text data, and program data.

In still another preferred embodiment, the visual information includes at least one of the title, file name and recording date of the data.

A recording method according to the present invention is characterized by including the steps of: generating a recording signal for recording visual information, showing the contents of data to be written on an information storage medium in a visible form, on the information storage medium; and recording the visual information on the information storage medium in response to the recording signal by using predetermined address information, which is stored on the information storage medium, as a reference for aligning the visual information being recorded such that the visual information is directly visible to a user.

Another recording apparatus according to the present invention is characterized by including: a recording section for generating a first recording signal for recording visual information, showing the contents of data to be written on an information storage medium in a visible form, on the information storage medium; and a head section for recording the visual information on the information storage medium in response to the first recording signal such that the visual information is directly visible to a user. The recording section further generates a second recording signal for writing location information, showing where the visual information has been recorded on the information storage medium, on the information storage medium. And the head section writes the location information on the information storage medium in response to the second recording signal.

In one preferred embodiment, in writing additional visual information, the head section aligns the additional visual information with the visual information that has already been recorded in accordance with the location information.

In another preferred embodiment, the head section records the visual information by using the storage location of predetermined address information, which is stored on the information storage medium, as a reference for aligning the visual information being recorded.

In still another preferred embodiment, the data includes at least one of video data, audio data, text data, and program data.

In yet another preferred embodiment, the visual information includes at least one of the file name, title and recording date of the data.

Another recording method according to the present invention is characterized by including the steps of: generating a first recording signal for recording visual information, showing the contents of data to be written on an information storage medium in a visible form, on the information storage medium; recording the visual information on the information storage medium in response to the first recording signal such that the visual information is directly visible to a user; generating a second recording signal for writing location information, showing where the visual information has been recorded on the information storage medium, on the information storage medium; and writing the location information on the information storage medium in response to the second recording signal.

Another recording apparatus according to the present invention is characterized by including: a recording section for generating a first recording signal for recording remaining space information, showing the space remaining on an information storage medium in a visible form, on the information storage medium; and a head section for recording the remaining space information on the information storage medium in response to the first recording signal such that the remaining space information is directly visible to a user.

In one preferred embodiment, at least one set of data and the remaining space information are already stored on the information storage medium. If new data has been added to the information storage medium, the recording section generates a second recording signal for recording update information, showing a remaining space that has changed due to the addition of the new data, on the information storage medium. And the head section records the update information on the information storage medium in response to the second recording signal and updates the remaining space information that is stored on the information storage medium.

In another preferred embodiment, the remaining space information is represented as a graphic and/or letters.

In still another preferred embodiment, the remaining space information is represented as a graphic and/or letters, and the update information is represented as an additional graphic and/or additional letters to be added to at least one of the graphic and the letters representing the remaining space information.

In yet another preferred embodiment, the remaining space information is represented as a ring, and the update information is represented as an additional ring that is concentric with the ring and that is added to either inside or outside of the ring on the information storage medium.

In yet another preferred embodiment, the information storage medium has a mark that indicates a reference location in a circumferential direction of the information storage medium, and the head section records the update information on the information storage medium by reference to the location of the mark such that the remaining space information and the update information are aligned with each other.

In yet another preferred embodiment, the head section records the update information on the information storage medium by reference to the storage location of predetermined address information, which is stored on the information storage medium, such that the remaining space information and the update information are aligned with each other.

In yet another preferred embodiment, the recording section further generates a third recording signal for writing location information, showing the storage location of the remaining space information on the information storage medium, on the information storage medium, and the head section writes the location information on the information storage medium in response to the third recording signal.

In this particular preferred embodiment, the head section records the update information on the information storage medium by reference to the location information such that the remaining space information and the update information are aligned with each other.

In yet another preferred embodiment, in erasing the remaining space information stored, the recording section generates an erase signal for erasing the remaining space information, and the head section erases the remaining space information in response to the erase signal.

In yet another preferred embodiment, the data includes at least one of video data, audio data, text data, and program data.

Another recording method according to the present invention is characterized by including the steps of: generating a recording signal for recording remaining space information, showing the space remaining on an information storage medium in a visible form, on the information storage medium; and recording the remaining space information on the information storage medium in response to the recording signal such that the remaining space information is directly visible to a user.

Although the present invention has been described with respect to preferred embodiments thereof, it should be understood that the foregoing description is only illustrative of the invention and that the true spirit and scope of the present invention be construed only by the appended claims. Also, it will be apparent that those with ordinary skills in the art could modify the disclosed invention in numerous ways and devise various embodiments other than those specifically described above. Furthermore, it should also be understood that the documents (including websites) cited in this description not only have their contents specifically mentioned above but also their disclosures are hereby incorporated by reference.

### INDUSTRIAL APPLICABILITY

A recording apparatus and recording method according to the present invention can be used particularly effectively in a field of technology in which visual information that is directly visible to the user is recorded on an information storage medium.

1. A recording apparatus comprising:
a recording section for generating a first recording signal for recording visual information, showing the contents of data to be written on an information storage medium in a visible form, on the information storage medium; and
a head section for recording the visual information on the information storage medium based on the first recording signal by using predetermined address information, which is stored on the information storage medium, as a reference for aligning the visual information being recorded such that the visual information is directly visible to a user.

2. The recording apparatus of claim 1, wherein the recording section further generates a second recording signal for writing location information, showing where the visual information has been recorded on the information storage medium, on the information storage medium, and
wherein the head section writes the location information on the information storage medium based on the second recording signal.

3. The recording apparatus of claim 1, wherein the data includes at least one of video data, audio data, text data, and program data.

4. The recording apparatus of claim 1, wherein the visual information includes at least one of the title, file name and recording date of the data.

5. A recording method comprising the steps of:
generating a recording signal for recording visual information, showing the contents of data to be written on an information storage medium in a visible form, on the information storage medium; and
recording the visual information on the information storage medium based on the recording signal by using predetermined address information, which is stored on the information storage medium, as a reference for aligning the visual information being recorded such that the visual information is directly visible to a user.

6. A recording apparatus comprising:
a recording section for generating a first recording signal for recording visual information, showing the contents of data to be written on an information storage medium in a visible form, on the information storage medium; and
a head section for recording the visual information on the information storage medium based on the first recording signal such that the visual information is directly visible to a user,
wherein the recording section further generates a second recording signal for writing location information, showing where the visual information has been recorded on the information storage medium, on the information storage medium, and
wherein the head section writes the location information on the information storage medium based on the second recording signal.

7. The recording apparatus of claim 6, wherein in writing additional visual information, the head section aligns the additional visual information with the visual information that has already been recorded in accordance with the location information.

8. The recording apparatus of claim 6, wherein the head section records the visual information by using the storage location of predetermined address information, which is stored on the information storage medium, as a reference for aligning the visual information being recorded.

9. The recording apparatus of claim 6, wherein the data includes at least one of video data, audio data, text data, and program data.

10. The recording apparatus of claim 6, wherein the visual information includes at least one of the file name, title and recording date of the data.

11. A recording method comprising the steps of:
generating a first recording signal for recording visual information, showing the contents of data to be written on an information storage medium in a visible form, on the information storage medium;
recording the visual information on the information storage medium based on the first recording signal such that the visual information is directly visible to a user;
generating a second recording signal for writing location information, showing where the visual information has been recorded on the information storage medium, on the information storage medium; and
writing the location information on the information storage medium based on the second recording signal.

12. A recording apparatus comprising:
a recording section for generating a first recording signal for recording remaining space information, showing the space remaining on an information storage medium in a visible form, on the information storage medium; and
a head section for recording the remaining space information on the information storage medium based on the first recording signal such that the remaining space information is directly visible to a user.

13. The recording apparatus of claim 12, wherein at least one set of data and the remaining space information are already stored on the information storage medium, and
wherein if new data has been added to the information storage medium, the recording section generates a second recording signal for recording update information, showing a remaining space that has changed due to the addition of the new data, on the information storage medium, and
wherein the head section records the update information on the information storage medium based on the second recording signal and updates the remaining space information that is stored on the information storage medium.

14. The recording apparatus of claim 12, wherein the remaining space information is represented as a graphic and/or letters.

15. The recording apparatus of claim 13, wherein the remaining space information is represented as a graphic and/or letters, and
wherein the update information is represented as an additional graphic and/or additional letters to be added to at least one of the graphic and the letters representing the remaining space information.

16. The recording apparatus of claim 13, wherein the remaining space information is represented as a ring, and
wherein the update information is represented as an additional ring that is concentric with the ring and that is added to either inside or outside of the ring on the information storage medium.

17. The recording apparatus of claim 13, wherein the information storage medium has a mark that indicates a reference location in a circumferential direction of the information storage medium, and
wherein the head section records the update information on the information storage medium by reference to the location of the mark such that the remaining space information and the update information are aligned with each other.

18. The recording apparatus of claim 13, wherein the head section records the update information on the information storage medium by reference to the storage location of predetermined address information, which is stored on the information storage medium, such that the remaining space information and the update information are aligned with each other.

19. The recording apparatus of claim 13, wherein the recording section further generates a third recording signal for writing location information, showing the storage location of the remaining space information on the information storage medium, on the information storage medium, and
wherein the head section writes the location information on the information storage medium based on the third recording signal.

20. The recording apparatus of claim 19, wherein the head section records the update information on the information storage medium by reference to the location information such that the remaining space information and the update information are aligned with each other.

21. The recording apparatus of claim 12, wherein in erasing the remaining space information stored, the recording section generates an erase signal for erasing the remaining space information, and
wherein the head section erases the remaining space information based on the erase signal.

22. The recording apparatus of claim 12, wherein the data includes at least one of video data, audio data, text data, and program data.

23. A recording method comprising the steps of:
generating a recording signal for recording remaining space information, showing the space remaining on an information storage medium in a visible form, on the information storage medium; and
recording the remaining space information on the information storage medium based on the recording signal such that the remaining space information is directly visible to a user.
